(19) United States
(12) Patent Application Publication
(10) Pub. No.: US 2019/0240824 A1
(43) Pub. Date: Aug. 8, 2019

(54) STAPLE REMOVER

(71) Applicant: KONICA MINOLTA, INC., Tokyo (JP)

(72) Inventors: SATOKO OHZAWA, Toyokawa-shi (JP); HIDEKI NARAHASHI, Toyokawa-shi (JP); RYUJI SATO, Toyohashi-shi (JP); YUKI HIGUCHI, Toyokawa-shi (JP)

(21) Appl. No.: 16/265,801

(22) Filed: Feb. 1, 2019

(30) Foreign Application Priority Data
Feb. 6, 2018 (JP) 2018-019291

(51) Int. Cl. B25C 11/00

(52) U.S. Cl. CPC B25C 11/00

(57) ABSTRACT

A staple remover for removing a staple from a bundle of papers fastened with the staple includes: a deformation assisting part that bends a part of the bundle, where the bundle has been fastened with the staple, with respect to a longitudinal direction of the staple; and a first blade inserted between the bent bundle and the staple, and removing the staple from the bundle, wherein the deformation assisting part includes a support part that supports the bundle, a communicating space is formed in the support part to allow a front surface and a back surface of the support part to communicate with each other in a thickness direction of the bundle, the bundle is disposed with the communicating space located below the staple, and the bundle enters the communicating space to be bent, by being caught between the support part and the first blade.

The entire disclosure of Japanese patent Application No. 2018-019291, filed on Feb. 6, 2018, is incorporated herein by reference in its entirety.

### BACKGROUND

### Technological Field

The present invention relates to a staple remover.

### Description of the Related Art

Techniques for inserting a blade between a staple and a bundle of papers and removing the staple from the bundle of papers are disclosed in JP 6-186809 A, JP 2015-147271 A, and JP 2016-101653 A.

With configurations disclosed in JP 6-186809 A, JP 2015-147271 A, and JP 2016-101653 A, there are cases where a blade cannot be inserted between a staple and a bundle of papers, and failure occurs in removal of the staple from the bundle of papers since the staple and the bundle of papers are in contact with each other.

### SUMMARY

An object of the present invention is to provide a staple remover capable of improving accuracy in removing a staple with a simple configuration.

To achieve the abovementioned object, according to an aspect of the present invention, a staple remover for removing a staple from a bundle of papers fastened with the staple reflecting one aspect of the present invention comprises: a deformation assisting part that bends a part of the bundle of papers, at which the bundle of papers has been fastened with the staple, with respect to a longitudinal direction of the staple; and a first blade that is inserted between the bent bundle of papers and the staple, and removes the staple from the bundle of papers, wherein the deformation assisting part includes a support part that supports the bundle of papers, a communicating space is formed in the support part so as to allow a front surface and a back surface of the support part to communicate with each other in a thickness direction of the bundle of papers, the bundle of papers is disposed such that the communicating space is located below the staple, and the bundle of papers enters the communicating space to be bent, by being caught between the support part and the first blade.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic top view of a staple remover according to a first embodiment;

FIG. 2 is a schematic sectional view of the staple remover taken along a line II-II shown in FIG. 1;

FIG. 3 is a sectional view of a stapled part of a bundle of papers;

FIG. 4 is a schematic front view of the bundle of papers, a staple, and a first blade which is being inserted therebetween;

FIG. 5 is a schematic sectional view of the staple remover taken along a line V-V shown in FIG. 4;

FIG. 6 is a schematic sectional view of the bundle of papers, the staple, and the first blade having been inserted therebetween;

FIG. 7 is a schematic front view of a staple remover according to a second embodiment;

FIG. 8 is a schematic front view of a staple remover according to a third embodiment;

FIG. 9 is a schematic sectional view of the staple remover taken along a line IX-IX shown in FIG. 8;

FIG. 10 is a schematic front view of a bundle of papers, a staple, and a first blade of the third embodiment, which is being inserted therebetween;

FIG. 11 is a schematic sectional view of the staple remover taken along a line XI-XI shown in FIG. 10;

FIG. 12 is a schematic front view of the bundle of papers, the staple, and the first blade of the third embodiment, which has been inserted therebetween;

FIG. 13 is a schematic sectional view of the staple remover taken along a line XIII-XIII shown in FIG. 12;

FIG. 14 is a schematic front view of the bundle of papers, the staple, and a second blade which is being inserted therebetween;

FIG. 15 is a schematic sectional view of the staple remover taken along a line XV-XV shown in FIG. 14;

FIG. 16 is a schematic front view of the bundle of papers, the staple, and the second blade having been inserted therebetween;

FIG. 17 is a schematic sectional view of the staple remover taken along a line XVII-XVII shown in FIG. 16;

FIG. 18 is a schematic view of a staple remover according to a fourth embodiment;

FIG. 19 is a schematic perspective view of a staple remover according to a fifth embodiment; and

FIG. 20 is a schematic front view of the staple remover shown in FIG. 19.

### DETAILED DESCRIPTION OF EMBODIMENTS

Hereinafter, one or more embodiments of the present invention will be described with reference to the drawings. However, the scope of the invention is not limited to the disclosed embodiments. In the following drawings, the same or corresponding parts are denoted by the same reference numerals, and description thereof will not be repeated.

### First Embodiment

<Staple Remover 1>

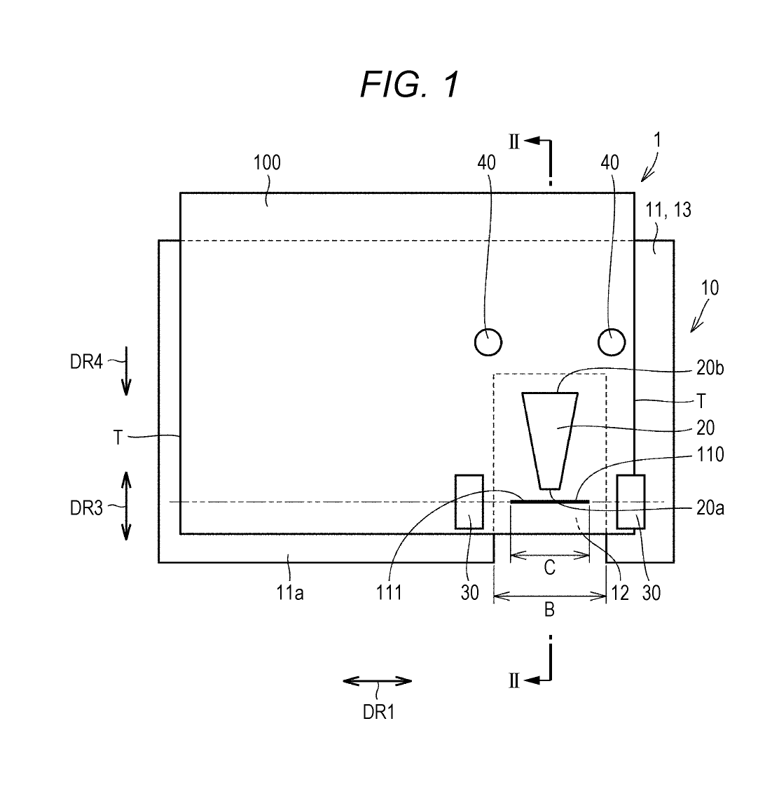

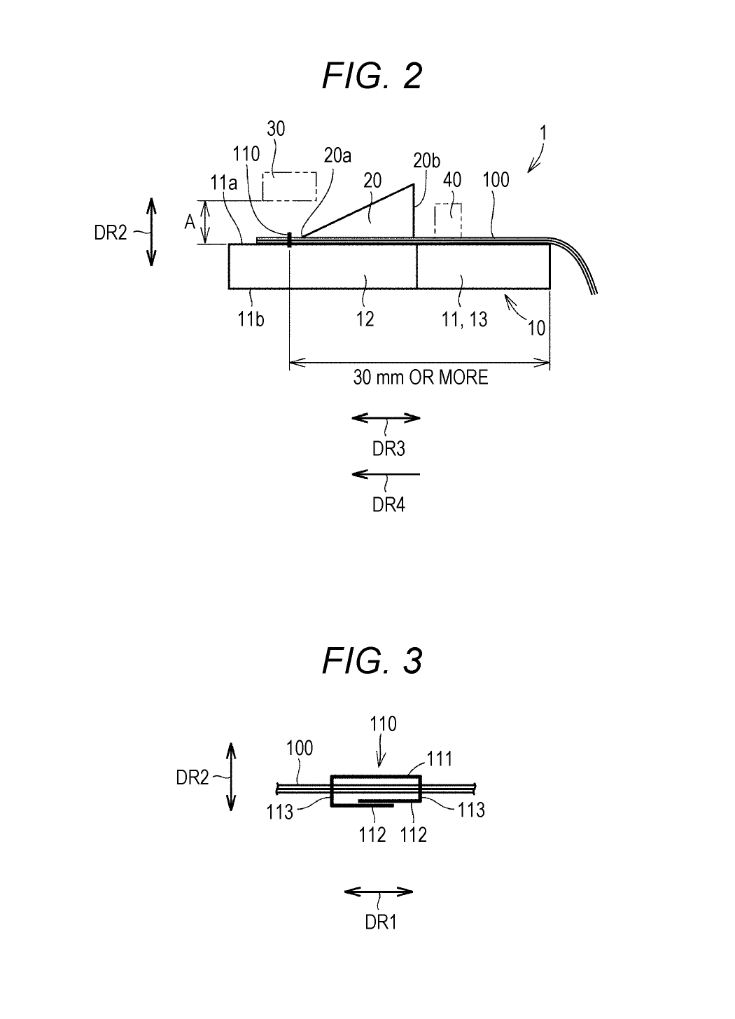

FIG. 1 is a schematic top view of a staple remover 1 according to a first embodiment. FIG. 2 is a schematic sectional view of the staple remover 1 taken along a line II-II shown in FIG. 1. FIG. 3 is a sectional view of a part of a bundle of papers 100, at which the bundle of papers 100 has been fastened with a staple 110. The staple remover 1 will be described with reference to FIGS. 1 to 3.

In order to hold the bundle of papers 100 together, the bundle of papers 100 has been fastened with the staple 110. The staple remover 1 removes the staple 110, which has fastened the bundle of papers 100, from the bundle of papers 100.

As shown in FIG. 3, the staple 110 fastens the bundle of papers 100 by being bent substantially in a U-shape. The staple 110 includes a crown 111, penetration parts 113, and legs 112. Each end of the crown 111 is connected to one end of the penetration part 113. The penetration part 113 penetrates the bundle of papers 100. The other end of the penetration part 113 is connected to one end of the leg 112. The leg 112 is shorter than the crown 111. The other end of the leg 112 is a free end. The crown 111 and the legs 112 face each other with the bundle of papers 100 interposed therebetween.

Double-headed arrows shown in the drawings indicate a longitudinal direction DR1, a thickness direction DR2, and an operation direction DR3. The longitudinal direction DR1 is a direction in which the crown 111 of the staple 110 extends, and is the horizontal direction in FIG. 1. The thickness direction DR2 is a direction of a thickness of the bundle of papers 100, and is orthogonal to the longitudinal direction DR1. The thickness direction DR2 is the vertical direction in FIG. 2. The operation direction DR3 is a direction orthogonal to the longitudinal direction DR1 and the thickness direction DR2, and is a direction in which a first blade 20 to be described below operates. The operation direction DR3 is the vertical direction in FIG. 1.

As shown in FIGS. 1 and 2, the staple remover 1 includes a deformation assisting part 10 and the first blade 20. The deformation assisting part 10 includes a support part 13 that supports the bundle of papers 100. The support part 13 supports the bundle of papers 100 from the leg 112 side of the staple 110. In the embodiment, the support part 13 is a placement table 11. The bundle of papers 100 is placed on the placement table 11. The placement table 11 has a substantially rectangular parallelepiped shape. In order to keep the bundle of papers 100 horizontal, the placement table 11 is made of a solid material such as metal and resin.

A communicating space 12 is formed in the placement table 11. The communicating space 12 allows a front surface 11a and a back surface 11b of the placement table 11 to communicate with each other in the thickness direction DR2. The communicating space 12 is formed away from ends of the placement table 11 in the longitudinal direction DR1. The staple 110 is disposed above the communicating space 12.

A difference between a width of the communicating space 12 (B in FIG. 1) in the longitudinal direction DR1 and a length of the staple 110 (C in FIG. 1) in the longitudinal direction DR1 is, for example, approximately 15 mm. It is preferable that in the longitudinal direction DR1, the difference between the width of the communicating space 12 and the length of the staple 110 is between 1 and 20 mm, inclusive.

The bundle of papers 100 is disposed such that the communicating space 12 is positioned below the staple 110. The bundle of papers 100 has ends T. The ends T are ends of the bundle of papers 100 in the longitudinal direction DR1. The ends T are not fixed on an extension line of the staple 110 in the longitudinal direction DR1 (a two-dot chain line in FIG. 1). The ends T are not pressed against the placement table 11 but are free ends on the extension line of the staple 110 in the longitudinal direction DR1.

The first blade 20 is disposed on the bundle of papers 100. The first blade 20 is disposed on the crown 111 side of the staple 110. The first blade 20 is operated in the operation direction DR3 by a driving source such as a motor (not shown). The first blade 20 advances in a direction of forward movement DR4, and is inserted between the bundle of papers 100 and the staple 110. The direction of forward movement DR4 is a direction in which the first blade 20 is inserted between the bundle of papers 100 and the staple 110, and is the downward direction in FIG. 1.

The first blade 20 has a wedge shape. The first blade 20 has a narrow end 20a and a wide end 20b. The narrow end 20a is an end of the first blade 20, positioned downstream in the direction of forward movement DR4. The wide end 20b is an end of the first blade 20, positioned upstream in the direction of forward movement DR4. A width of the first blade 20 in the longitudinal direction DR1 decreases from the wide end 20b toward the narrow end 20a. In order to facilitate insertion of the first blade 20 between the staple 110 and the bundle of papers 100, it is preferable to reduce a thickness of the narrow end 20a as far as possible in consideration of its strength.

The staple remover 1 further includes holding members 40 and lift prevention members 30. The holding members 40 have a cylindrical shape. The holding members 40 are disposed upstream of the staple 110 in a direction (direction of forward movement DR4) in which the first blade 20 is inserted between the bundle of papers 100 and the staple 110. The holding members 40 press the bundle of papers 100 against the placement table 11. Thus, the bundle of papers 100 is held at a point located upstream of the staple 110 in the direction of forward movement DR4.

The lift prevention members 30 restrict movement of the bundle of papers 100 in a direction in which the bundle of papers 100 lifts when the staple 110 is removed by the first blade 20. The lift prevention members 30 are disposed away from the bundle of papers 100 before the staple 110 is removed by the first blade 20. The lift prevention members 30 are disposed at positions away from the staple 110 along the longitudinal direction DR1. The lift prevention members 30 are disposed on both sides of the staple 110 in the longitudinal direction DR1. In the embodiment, the staple 110 is disposed between the two lift prevention members 30.

A distance (A in FIG. 2) from the lift prevention members 30 to the support part 13 (placement table 11) in the thickness direction DR2 is larger than a thickness of the bundle of papers 100 in the case where the number of paper sheets included in the bundle of papers 100 is equal to a maximum allowable number of sheets for staple removal. The maximum allowable number of sheets for staple removal refers to the maximum number of paper sheets to be included in the bundle of papers 100 from which the staple remover 1 can remove the staple 110.

<Operation of Staple Remover 1>

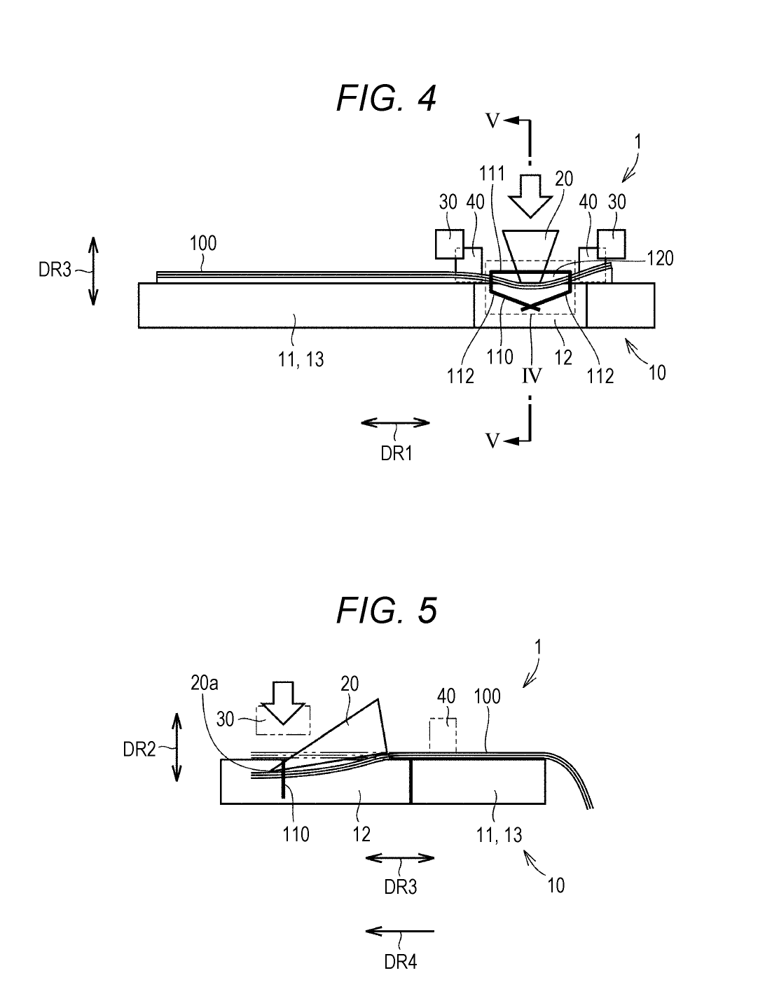

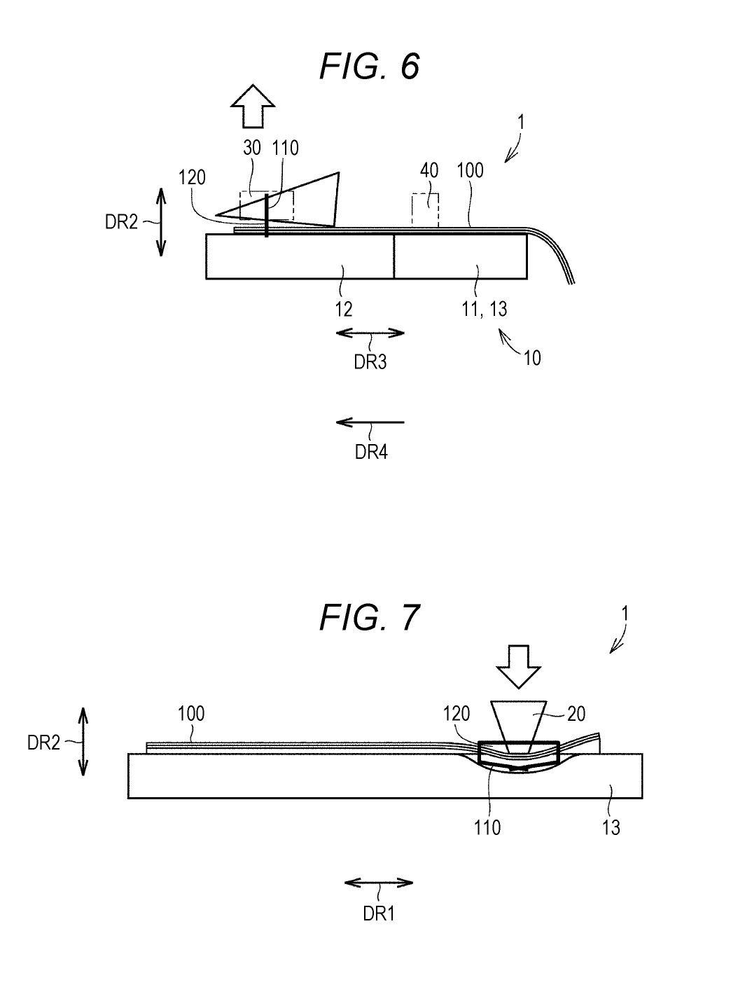

FIG. 4 is a schematic front view of the bundle of papers 100, the staple 110, and the first blade 20 which is being inserted therebetween. FIG. 5 is a schematic sectional view of the staple remover 1 taken along a line V-V shown in FIG. 4. FIG. 6 is a schematic sectional view of the bundle of papers 100, the staple 110, and the first blade 20 having been inserted therebetween. In FIG. 4, the staple 110 is shown in section (hereinafter the same applies to all schematic front views). Operation of the staple remover 1 will be described with reference to FIGS. 4 to 6.

The deformation assisting part 10 further includes a first pressing/separating mechanism including a spring and the like (not shown). The first blade 20 is pressed against the bundle of papers 100 by means of the above-described first pressing/separating mechanism. While being pressed against the bundle of papers 100 (outlined arrows in FIGS. 4 and 5), the first blade 20 advances toward the staple 110 along the direction of forward movement DR4 by means of the driving source (not shown).

When reaching the communicating space 12, the first blade 20 advances while bending the bundle of papers 100 downward as shown in FIGS. 4 and 5. At this time, the bundle of papers 100 enters the communicating space 12 to be bent, by being caught between the placement table 11 and the first blade 20. The part of the bundle of papers 100 at which the bundle of papers 100 has been fastened with the staple 110 (an area IV in FIG. 4) is bent, with respect to the longitudinal direction DR1, by the deformation assisting part 10 (the placement table 11 and the first pressing/separating mechanism).

When the first blade 20 holds down the bundle of papers 100, the thickness of a part of the bundle of papers 100, at which the bundle of papers 100 has been held down by the first blade 20, is reduced by a decrease in spaces between paper sheets in the bundle of papers 100 and compression of the paper sheets constituting the bundle of papers 100. Furthermore, as the legs 112 of the staple 110 are unfolded by a deformation of the bundle of papers 100, the bundle of papers 100 become capable of moving downward without being restricted by the legs 112.

Thus, the thickness of the part of the bundle of papers 100, at which the bundle of papers 100 has been held down by the first blade 20, is reduced. In addition, the bundle of papers 100 becomes capable of moving downward. As a result, a space 120 is formed between the bundle of papers 100 and the crown 111 of the staple 110. The narrow end 20a of the first blade 20 is inserted into the space 120 formed by the bending of the bundle of papers 100.

As shown in FIG. 6, after the narrow end 20a of the first blade 20 is inserted into the space 120, the first blade 20 further advances to increase the space 120. After being inserted into the space 120, the first blade 20 advances along the direction of forward movement DR4 to remove the staple 110 from the bundle of papers 100 while moving, by means of the first pressing/separating mechanism, in a direction away from the bundle of papers 100 (while raising the bundle of papers 100) as indicated by an outlined arrow shown in FIG. 6.

(Operational Effects)

As shown in FIG. 4, the deformation assisting part 10 bends the part of the bundle of papers 100, at which the bundle of papers 100 has been fastened with the staple 110, with respect to the longitudinal direction DR1 of the staple 110. As a result, the space 120 is formed between the staple 110 and the bundle of papers 100. As a result of the formation of the space 120, it becomes easy to insert the first blade 20 between the bundle of papers 100 and the staple 110. Therefore, it is possible to improve accuracy in removing the staple 110.

Furthermore, it is possible to bend the bundle of papers 100 with a simple configuration by adopting the support part 13 (placement table 11) in which the communicating space 12 is formed.

In the first embodiment, the bundle of papers 100 is fixed on the support part 13 (placement table 11), and the staple 110 is removed from the bundle of papers 100 by the first blade 20 operating in the operation direction DR3. It is possible to remove the staple 110 while stabilizing the bundle of papers 100 by adopting a configuration in which the bundle of papers 100 is fixed on the support part 13 and a removal mechanism including the first blade 20 and the first pressing/separating mechanism is operated.

Furthermore, even when the bundle of papers 100 is fastened with a plurality of staples 110, it is possible to remove the plurality of staples 110 without separately providing another removal mechanism, by adopting a configuration in which the above-described removal mechanism is rotatable and movable in a plurality of directions.

It is preferable that as shown in FIG. 1, the difference between the width (B in FIG. 1) of the communicating space 12 and the length (C in FIG. 1) of the staple 110 in the longitudinal direction DR1 is between 1 and 20 mm, inclusive. In the case where the difference between the width of the communicating space 12 and the length of the staple 110 is small, a large curvature can be obtained even if the bundle of papers 100 is slightly bent.

However, greater force is necessary for bending the bundle of papers 100. In the case where the difference between the width of the communicating space 12 and the length of the staple 110 is large, the bundle of papers 100 can be bent with small force. However, it is necessary to increase an amount of a bend of the bundle of papers 100. It is possible to efficiently bend the bundle of papers 100 by properly setting the difference between the width of the communicating space 12 and the length of the staple 110 in the longitudinal direction DR1.

The ends T are not pressed against the placement table 11 but are free ends on the extension line of the staple 110 in the longitudinal direction DR1. As a result, it is possible to secure space for bending the bundle of papers 100.

The bundle of papers 100 is held while being pressed down by the holding members 40 located upstream of the staple 110 in a direction in which the first blade 20 is inserted (direction of forward movement DR4). Therefore, it is possible to prevent the bundle of papers 100 from being twisted in the operation direction DR3 when inserting the first blade 20 between the bundle of papers 100 and the staple 110.

As shown in FIG. 2, it is preferable that before being bent by the deformation assisting part 10, the bundle of papers 100 is substantially horizontal without a bend, for 30 mm or more from the staple 110 in a direction opposite to the direction (direction of forward movement DR4) in which the first blade 20 is inserted. When there is a bend, the bundle of papers 100 is, for example, creased, and the creases and the like hinder the bundle of papers 100 from being bent with respect to the longitudinal direction DR1. It is possible to effectively bend the bundle of papers 100 by keeping the bundle of papers 100 substantially horizontal for 30 mm or more from the staple 110 in the direction opposite to the direction of forward movement DR4.

The lift prevention members 30 are disposed away from the bundle of papers 100 before the staple 110 is removed by the first blade 20. As a result, even with a configuration in which the first blade 20 removes the staple 110 from the bundle of papers 100 while raising the bundle of papers 100, it is possible to prevent failure in removal of the staple 110 caused by the bundle of papers 100 being hung by the first blade 20.

Furthermore, with the adoption of the lift prevention members 30, it is possible to remove the staple 110 by an action of raising the bundle of papers 100 in a direction in which the bundle of papers 100 lifts, even without forming the first blade 20 in a wedge shape, while adopting the first blade 20 having a small thickness as a whole.

It is preferable that the lift prevention members 30 are disposed at positions away from the staple 110 along the longitudinal direction DR1. As a result, it is possible to further prevent the bundle of papers 100 from being hung by the first blade 20 when the first blade 20 removes the staple 110 from the bundle of papers 100 while raising the bundle of papers 100.

It should be noted that the lift prevention members 30 may be disposed upstream of the staple 110 in the direction in which the first blade 20 is inserted. Even in such a case, it is possible to achieve an effect of preventing the bundle of papers 100 from being hung by the first blade 20, as with the above-described case.

The distance (A in FIG. 2) from the lift prevention members 30 to the support part 13 in the thickness direction DR2 is larger than the thickness of the bundle of papers 100 in the case where the number of paper sheets included in the bundle of papers 100 is equal to the maximum allowable number of sheets for staple removal. As a result, even when the number of paper sheets included in the bundle of papers 100 is equal to the maximum allowable number of sheets for staple removal, the lift prevention members 30 are disposed away from the bundle of papers 100. Therefore, when inserting the first blade 20 between the bundle of papers 100 and the staple 110, it is possible to prevent the bundle of papers 100 from being twisted in the operation direction DR3.

The first blade 20 has a wedge shape. Therefore, the staple 110 can be removed from the bundle of papers 100 just by forward movement of the first blade 20. Furthermore, even if the direction of forward movement DR4 of the first blade 20 is not orthogonal to the longitudinal direction DR1, the first blade 20 can be easily inserted between the staple 110 and the bundle of papers 100.

On the assumption that the staple 110 and the first blade 20 are misaligned (the direction of forward movement DR4 is not orthogonal to the longitudinal direction DR1) as described above, it is preferable that the first blade 20 has a certain degree of freedom for a direction of rotation around a central axis along the longitudinal direction DR1 or the thickness direction DR2.

As the first blade 20 continues to advance after being inserted between the staple 110 and the bundle of papers 100, a part of the first blade 20 with a large width in the longitudinal direction DR1 comes into contact with the crown 111 of the staple 110. Therefore, it is possible to prevent removal of only one of the legs 112 when removing the staple 110 from the bundle of papers 100.

### Second Embodiment

FIG. 7 is a schematic front view of a staple remover 1 according to a second embodiment. Unlike the first embodiment, a support part 13 of the second embodiment is formed of an elastic member. No communicating space 12 is formed in the support part 13 of the second embodiment. As in the first embodiment, while being pressed against a bundle of papers 100 (an outlined arrow in FIG. 7), a first blade 20 advances toward a staple 110 along a direction of forward movement DR4 by means of a first pressing/separating mechanism (not shown). As a result, pressure is applied to the support part 13 via the bundle of papers 100. As the bundle of papers 100 is bent, the support part 13 deforms. As a result, a space 120 is formed between the bundle of papers 100 and the staple 110.

With the support part 13 formed of an elastic member, it is possible to bend the bundle of papers 100 even when no communicating space 12 is formed below the staple 110. Therefore, the staple 110 can be removed at any given position on the support part 13. Furthermore, it is not necessary to form the communicating space 12 in the support part 13. Thus, manufacturing cost can be reduced.

### Third Embodiment

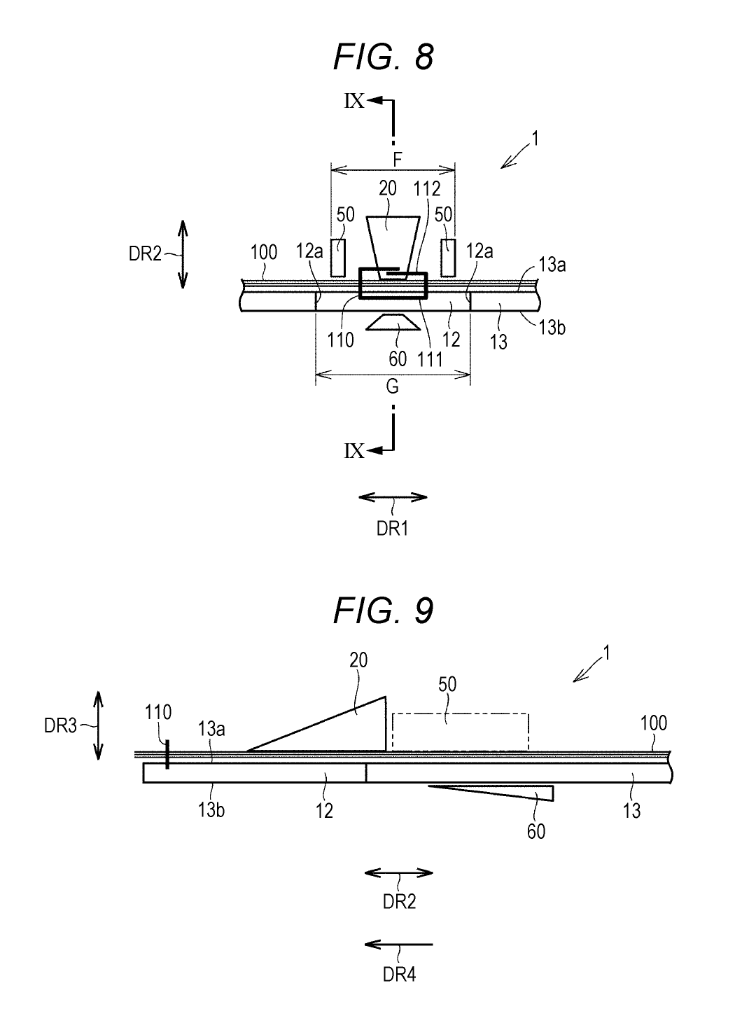

FIG. 8 is a schematic front view of a staple remover 1 according to a third embodiment. FIG. 9 is a schematic sectional view of the staple remover 1 taken along a line IX-IX shown in FIG. 8. The staple remover 1 according to the third embodiment will be described with reference to FIGS. 8 and 9.

Unlike the first embodiment, a support part 13 supports a bundle of papers 100 from a crown 111 side of a staple 110. A first blade 20 is disposed on a leg 112 side of the staple 110. Unlike the first embodiment, the staple remover 1 according to the third embodiment further includes pressing parts 50 and a second blade 60.

The pressing parts 50 are disposed on the leg side of the staple 110. The pressing parts 50 have a rectangular parallelepiped shape. In the embodiment, the two pressing parts 50 are disposed so as to interpose the first blade 20 therebetween in a longitudinal direction DR1. The second blade 60 is disposed on the crown 111 side of the staple 110. The second blade 60 has a wedge shape. The second blade 60 is disposed upstream of the first blade 20 in a direction in which the first blade 20 is inserted (direction of forward movement DR4). The second blade 60 is operated in an operation direction DR3 by a driving source such as a motor (not shown).

A communicating space 12 is formed in the support part 13. The communicating space 12 of the third embodiment allows a front surface 13a and a back surface 13b of the support part 13 to communicate with each other in a thickness direction DR2. The bundle of papers 100 is disposed such that the communicating space 12 is positioned below the staple 110. The pressing parts 50 are disposed inside an edge 12a of the communicating space 12 in the longitudinal direction DR1. In the longitudinal direction DR1, a distance (F in FIG. 8) between the pressing parts 50 is smaller than a width (G in FIG. 8) of the communicating space 12.

As in the first embodiment, a deformation assisting part 10 includes a first pressing/separating mechanism (not shown). Unlike the first embodiment, the deformation assisting part 10 of the third embodiment further includes a second pressing/separating mechanism (not shown). The second blade 60 is pressed upward by the above-described second pressing/separating mechanism. While being pressed upward, the second blade 60 advances toward the staple 110 along the direction of forward movement DR4 by means of the driving source.

(Operation of Staple Remover 1 of Third Embodiment)

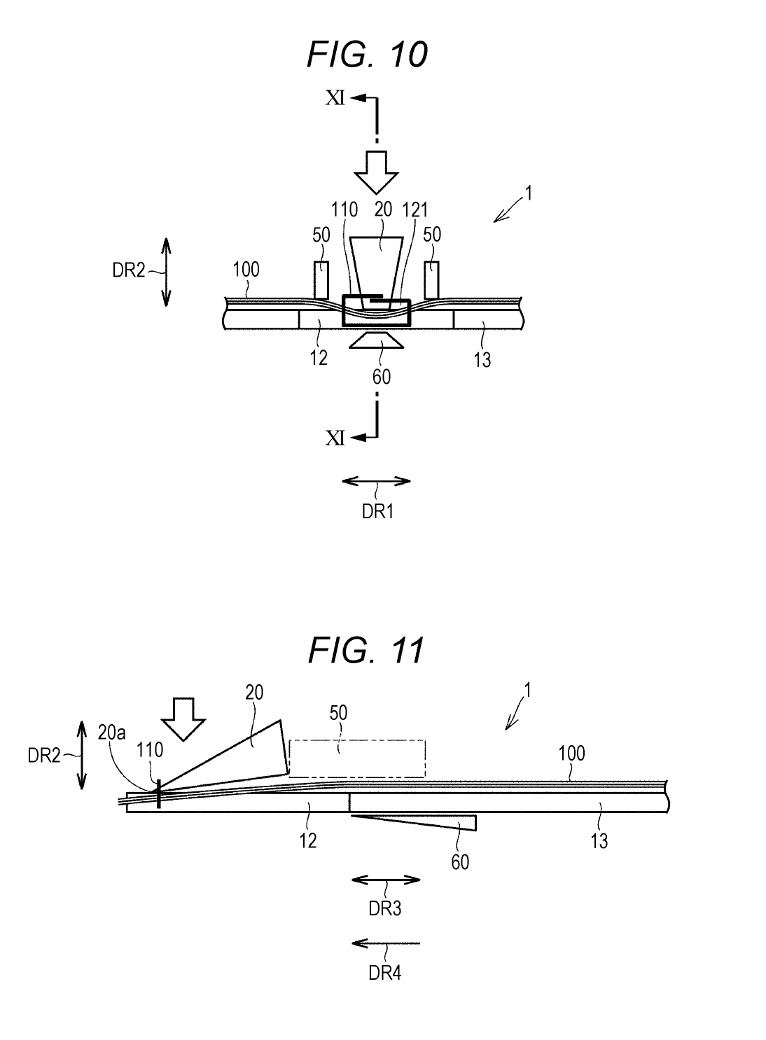

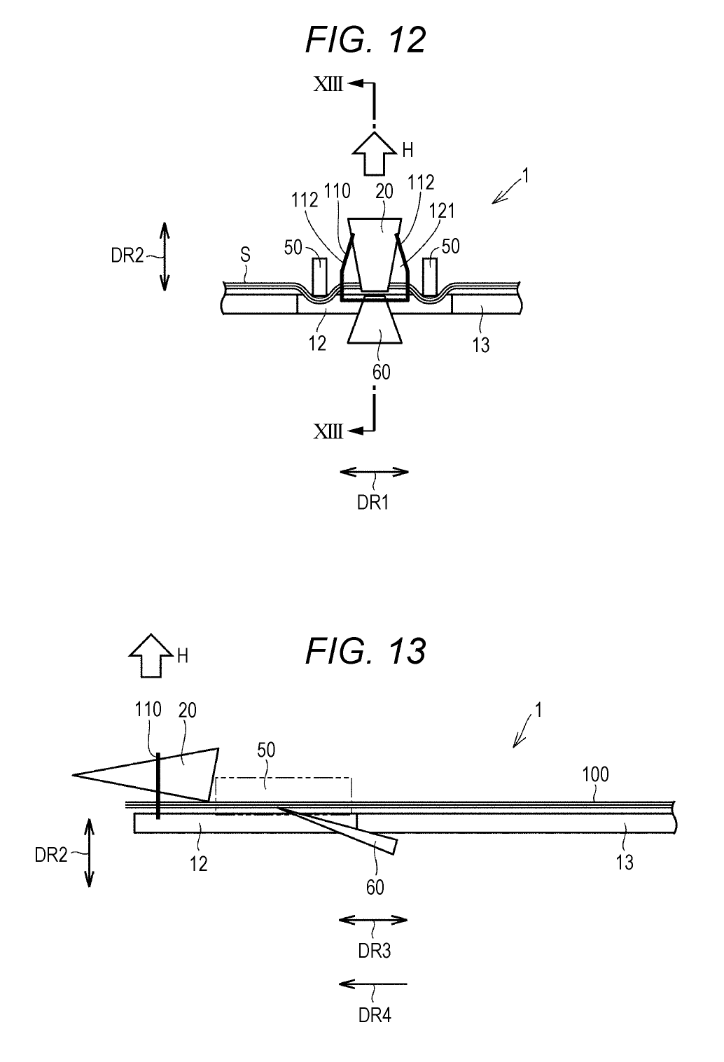

FIG. 10 is a schematic front view of the bundle of papers 100, the staple 110, and the first blade 20 of the third embodiment, which is being inserted therebetween. FIG. 11 is a schematic sectional view of the staple remover 1 taken along a line XI-XI shown in FIG. 10. FIG. 12 is a schematic front view of the bundle of papers 100, the staple 110, and the first blade 20 of the third embodiment, which has been inserted therebetween. FIG. 13 is a schematic sectional view of the staple remover 1 taken along a line XIII-XIII shown in FIG. 12. Operation of the first blade 20 according to the third embodiment will be described with reference to FIGS. 10 to 13.

When reaching the communicating space 12, the first blade 20 advances while bending the bundle of papers 100 as shown in FIGS. 10 and 11. At this time, the bundle of papers 100 enters the communicating space 12 to be bent, by being caught between the support part 13 and the first blade 20. As the first blade 20 holds down the bundle of papers 100, a space 121 is formed between the bundle of papers 100 and the legs 112 of the staple 110. A narrow end 20a of the first blade 20 is inserted into the space 121 formed by the bending of the bundle of papers 100. The pressing parts 50 and the second blade 60 advance in the direction of forward movement DR4 in conjunction with the first blade 20. It is preferable that there is provided a mechanism that causes the pressing parts 50, the second blade 60, and the first blade 20 to integrally operate.

As shown in FIGS. 12 and 13, after the narrow end 20a of the first blade 20 is inserted into the space 121, the first blade 20 further advances to increase the space 121. The first blade 20 moves in a direction away from the bundle of papers 100 by means of the first pressing/separating mechanism (an outlined arrow H in FIGS. 12 and 13). While moving away from the bundle of papers 100, the first blade 20 advances along the direction of forward movement DR4 to unfold the legs 112 of the staple 110. When the first blade 20 unfolds the legs 112 of the staple 110, the pressing parts 50 serve a similar function to that of the lift prevention members 30.

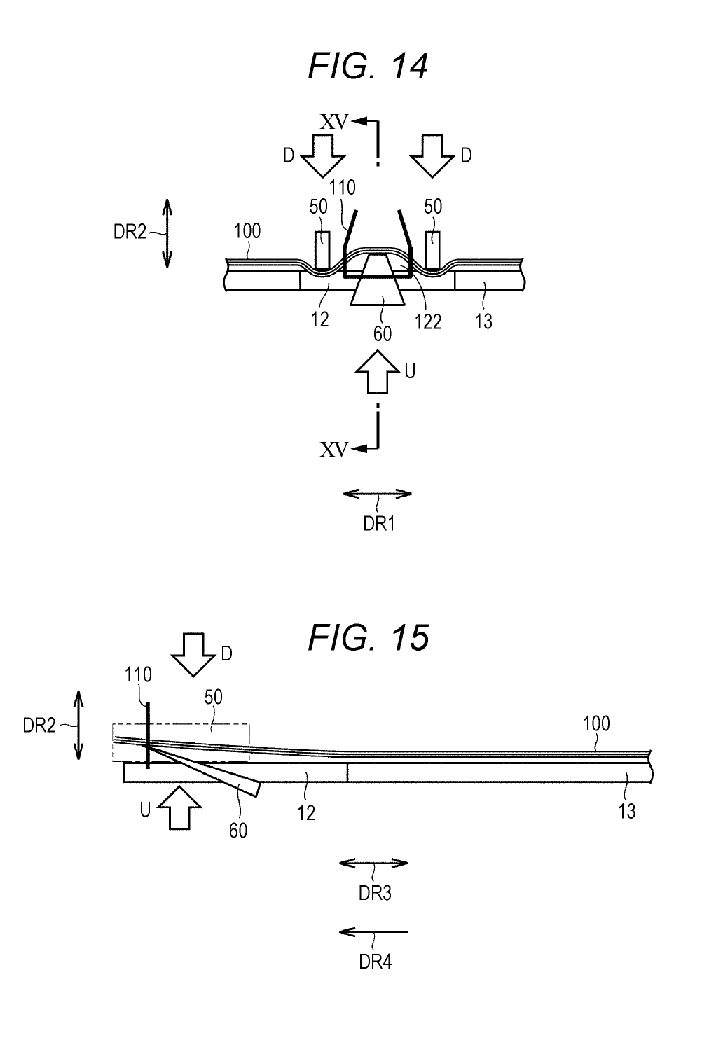

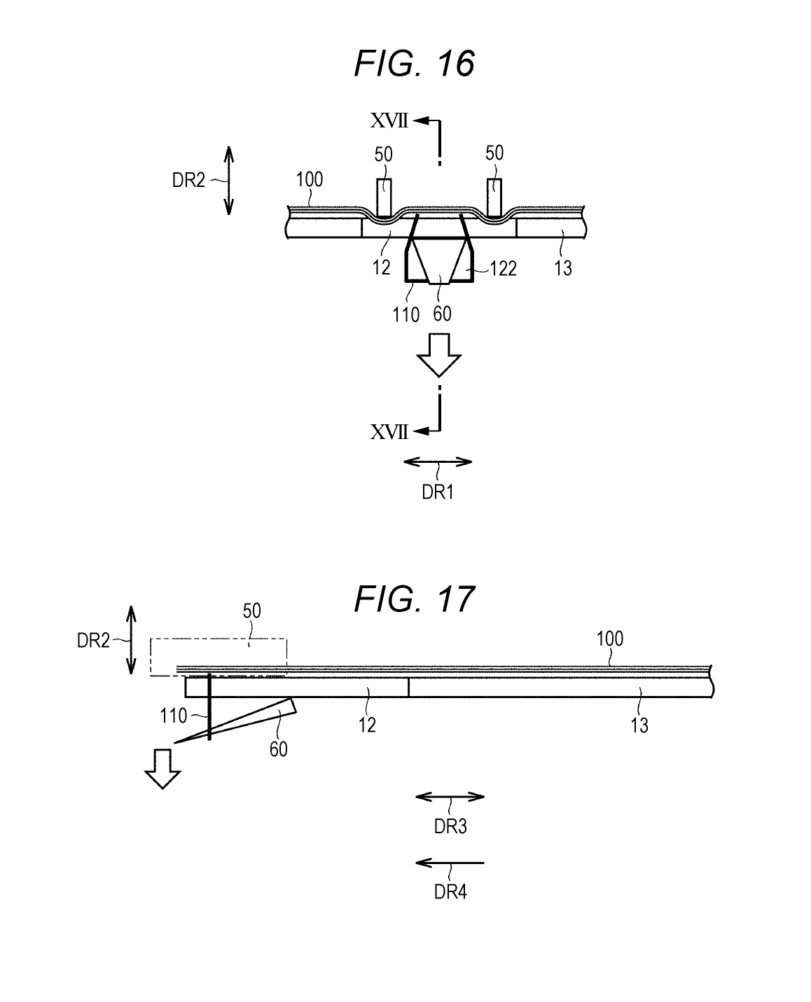

FIG. 14 is a schematic front view of the bundle of papers 100, the staple 110, and the second blade 60 which is being inserted therebetween. FIG. 15 is a schematic sectional view of the staple remover 1 taken along a line XV-XV shown in FIG. 14. FIG. 16 is a schematic front view of the bundle of papers 100, the staple 110, and the second blade 60 having been inserted therebetween. FIG. 17 is a schematic sectional view of the staple remover 1 taken along a line XVII-XVII shown in FIG. 16. Operation of the second blade 60 will be described with reference to FIGS. 14 to 17.

When reaching the communicating space 12, the pressing parts 50 advance while pressing down the bundle of papers 100 (outlined arrows D in FIGS. 14 and 15) as shown in FIGS. 14 and 15. When reaching the communicating space 12, the second blade 60 presses the bundle of papers 100, by means of the second pressing/separating mechanism, in a direction in which the bundle of papers 100 is raised (an outlined arrow U in FIGS. 14 and 15). The second blade 60 advances along the direction of forward movement DR4 while pressing the bundle of papers 100 upward. At this time, the bundle of papers 100 enters the communicating space 12 to be bent, by being caught between the pressing parts 50 and the second blade 60. A space 122 is formed between the bundle of papers 100 and the crown 111 of the staple 110 by the second blade 60 pressing the bundle of papers 100 upward. The second blade 60 is inserted into the space 122 formed by the bending of the bundle of papers 100.

As shown in FIGS. 16 and 17, after being inserted into the space 122, the second blade 60 further advances, and removes the staple 110 from the bundle of papers 100 while moving away from the bundle of papers 100 by means of the second pressing/separating mechanism (outlined arrows in FIGS. 16 and 17). The second blade 60 pulls the staple 110 in a downward direction. When the second blade 60 pulls the staple 110, the support part 13 serves a similar function to that of the lift prevention members 30.

(Operational Effects)

The first blade 20 unfolds the legs 112 of the staple 110. Then, the second blade 60 is inserted between the crown 111 of the staple 110 and the bundle of papers 100. Thus, the staple 110 is removed in two steps. As a result, it is possible to reduce damage to the bundle of papers 100. Furthermore, it is possible to increase a maximum allowable number of sheets for staple removal of the staple remover 1.

The second blade 60 is disposed upstream of the first blade 20 in the direction of forward movement DR4. Therefore, it is possible to prevent the first blade 20 from hindering the second blade 60 from bending the bundle of papers 100.

Since the communicating space 12 is formed in the support part 13, the bundle of papers 100 can enter the communicating space 12 to be bent. As a result, it is possible to bend the bundle of papers 100 with a simple configuration.

As shown in FIG. 8, it is preferable that the distance (F in FIG. 8) between the pressing parts 50 in the longitudinal direction DR1 is smaller than the width (G in FIG. 8) of the communicating space 12 in the longitudinal direction DR1. As a result, the pressing parts 50 can enter the communicating space 12 to press down the bundle of papers 100. Therefore, it is possible to reduce an amount of movement of the second blade 60 pushing the bundle of papers 100 upward. Thus, the staple remover 1 can be made compact.

The second blade 60 pulls the staple 110 in the downward direction. It is thus possible to prevent the staple remover 1 from being damaged by the staple 110 flipped upward. It is possible to surely retrieve the staple 110 by disposing a magnetic material or the like in the direction in which the staple 110 is pulled. Therefore, it is possible to surely prevent the staple remover 1 from being damaged.

Both the first blade 20 and the second blade 60 are formed in a wedge shape. As a result, it is possible to remove the staple 110 by driving the first blade 20 and the second blade 60 only in the direction of forward movement DR4. It should be noted that it is possible to prevent the staple 110 from applying force to the bundle of papers 100 in the direction of forward movement DR4, by causing an edge of the first blade 20 to move away from the bundle of papers 100 after inserting the first blade 20 between the staple 110 and the bundle of papers 100. Incidentally, the same applies to the second blade 60.

### Fourth Embodiment

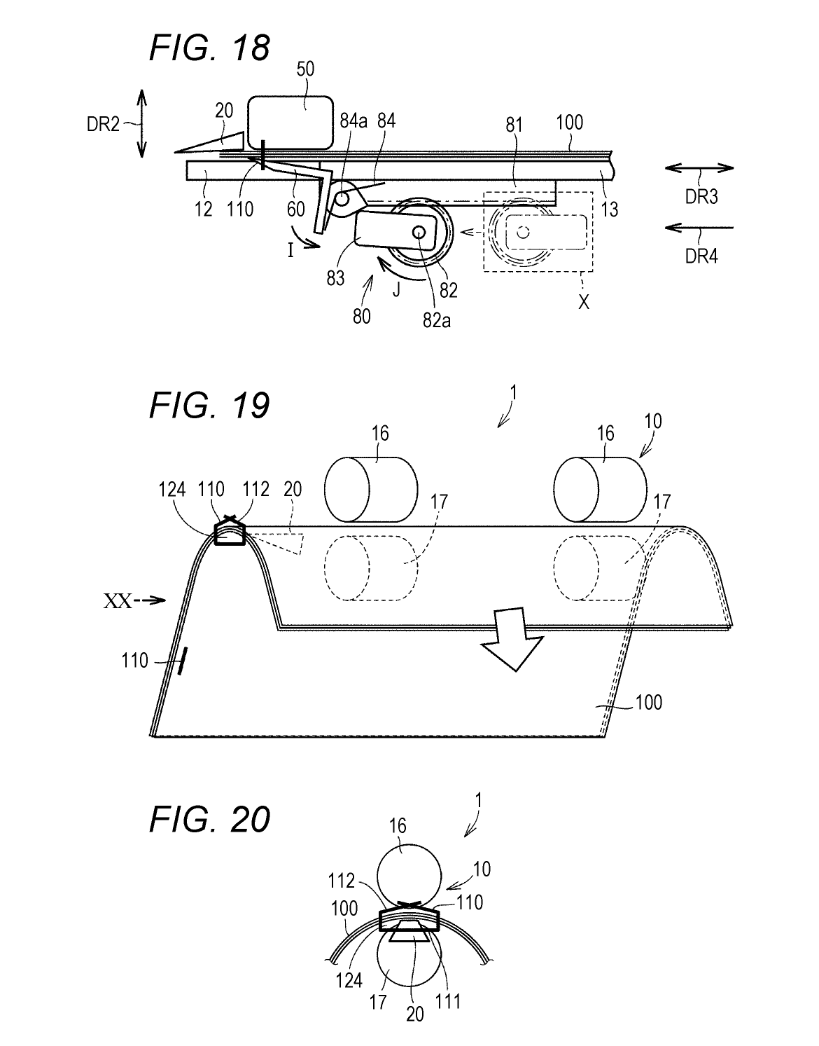

FIG. 18 is a schematic view of a staple remover 1 according to a fourth embodiment. As in the third embodiment, the fourth embodiment adopts a configuration in which a second blade 60 removes a staple 110 after a first blade 20 unfolds legs 112 of the staple 110.

A second pressing/separating mechanism of the fourth embodiment is a cam mechanism 80. The cam mechanism 80 includes a rack 81, a pinion gear 82, an intermediary member 83, a spring 84, and a cam 85. The rack 81 is provided under a support part 13. The support part 13 is fixed. The rack 81 is provided with a tooth profile formed so as to be engaged with the pinion gear 82.

The pinion gear 82 is engaged with the rack 81 to rotate. The pinion gear 82 operates in an operation direction DR3. The intermediary member 83 rotates around the same axis as that of the pinion gear 82. The second blade 60 is urged by the spring 84 in the clockwise direction. Urging force of the spring 84 causes the second blade 60 to press a lower side of the support part 13. The second blade 60 advances in a direction of forward movement DR4. When reaching a communicating space 12, the second blade 60 presses a lower side of a bundle of papers 100. The second blade 60 advances in the direction of forward movement DR4 in conjunction with the first blade 20, pressing parts 50, and the pinion gear 82.

In a step preceding a step in which the first blade 20 unfolds the legs 112 of the staple 110, the pinion gear 82 and the intermediary member 83 are disposed in an area X shown in FIG. 18. In a step in which the first blade 20 unfolds the legs 112 of the staple 110 and the second blade 60 removes the staple 110, the pinion gear 82 and the intermediary member 83 advance from the area X in the direction of forward movement DR4. As the pinion gear 82 advances in the direction of forward movement DR4, the intermediary member 83 rotates clockwise around a shaft 82a (an arrow J in FIG. 18). As the intermediary member 83 rotates clockwise, the intermediary member 83 comes into contact with the cam 85 to rotate the cam 85 counterclockwise (an arrow I in FIG. 18). The cam 85 applies force to the second blade 60 in the counterclockwise direction. The counterclockwise rotational force applied by the cam 85 exceeds the clockwise urging force applied by the spring 84. This causes operation of pulling the staple 110 from the bundle of papers 100 to be performed.

The first blade 20, the pressing parts 50, the second blade 60, the pinion gear 82, and the cam 85 operate in conjunction with one another. Therefore, it is possible to perform operation of inserting the first blade 20 and the second blade 60 between the staple 110 and the bundle of papers 100, and operation of pulling the staple 110, with a single driving source.

### Fifth Embodiment

FIG. 19 is a schematic perspective view of a staple remover 1 according to a fifth embodiment. FIG. 20 is a schematic front view of the staple remover 1 shown in FIG. 19. FIG. 20 shows a schematic front view in an XX direction shown in FIG. 19. A deformation assisting part 10 of the fifth embodiment includes conveying rollers 16 and counter rollers 17. The conveying rollers 16 are disposed on a leg 112 side of a staple 110. The counter rollers 17 face the conveying rollers 16 via a bundle of papers 100. The bundle of papers 100 fastened with the staple 110 is conveyed by the conveying rollers 16 and the counter rollers 17 along a direction in which the staple 110 extends.

A conveyance path for the bundle of papers 100 is formed such that the bundle of papers 100 straddles the counter rollers 17. When the staple 110 reaches a turnback part, conveyance of the bundle of papers 100 is temporarily stopped. In this state, operation of removing the staple 110 is performed.

When the staple 110 reaches the turnback part, the bundle of papers 100 is held by the conveying rollers 16 and the counter rollers 17. As a result, a part of the bundle of papers 100 enclosed by the staple 110 is bent to form a space 124 between a crown 111 of the staple 110 and the bundle of papers 100. By inserting a first blade 20 into the space 124, it is possible to remove the staple 110 from the bundle of papers 100.

Incidentally, it is also possible to form a space between the staple 110 and the bundle of papers 100 by placing the entire bundle of papers 100 on a table with curvature, and bending the part of the bundle of papers 100 enclosed by the staple 110. In this case, it is preferable that a radius of curvature of the bent part is, for example, approximately twice as long as a length of the crown 111 of the staple 110.

(Other)

In the first embodiment, the holding member 40 may be disposed at a single point on the same line as the staple 110 in the operation direction DR3 so that the bundle of papers 100 does not rotate or move when the staple 110 is removed from the bundle of papers 100. The holding members 40 may be symmetrically arranged at a plurality of positions with respect to the staple 110 and the above-described same line.

In the first embodiment, the bundle of papers 100 is caught between the placement table 11 and the first blade 20 in a staggered manner, so that the space 120 is formed. Meanwhile, the bundle of papers 100 may be bent by use of a pressing member having another configuration instead of the first blade 20. During operation of removing the staple 110, the above-described pressing member is held at a specific position without being moved. As a result, the first blade 20 can move on the bundle of papers 100 without pressing the bundle of papers 100. This can reduce damage to the bundle of papers 100 caused by the narrow end 20a of the first blade 20 when the narrow end 20a rubs a surface of the bundle of papers 100.

In the first embodiment, the staple 110 is disposed at a single position. Meanwhile, there are cases where the staples 110 are disposed at several positions. In that case, in order to remove a plurality of the staples 110, it is preferable that the communicating spaces 12 are formed at a plurality of positions below the respective ones of the plurality of staples 110.

In the first embodiment, when there is a plurality of bundles of papers 100 from which the staples 110 are to be removed, operation of removing the staples 110 may be performed in a state where the plurality of bundles of papers 100 is stacked in consideration of continuity. However, stacking a plurality of bundles of papers 100 increases uncertainties such as a difference in height between a part where the staples 110 are stacked and the other part. Therefore, it is preferable that the plurality of bundles of papers 100 is conveyed to be placed on the placement table 11 one by one.

It is not necessary for the support part 13 of the second embodiment to be formed of an elastic member in its entirety. The support part 13 may be partially formed of an elastic member.

The support part 13 of the third embodiment may be configured such that support tables formed in a rectangular parallelepiped shape extending in the operation direction DR3 are provided on both sides of the communicating space 12.

In the third embodiment, the distance (F in FIG. 8) between the pressing parts 50 in the longitudinal direction DR1 may be equal to or larger than the width (G in FIG. 8) of the communicating space 12 in the longitudinal direction DR1.

Although embodiments of the present invention have been described and illustrated in detail, the disclosed embodiments are made for purposes of illustration and example only and not limitation. The scope of the present invention should be interpreted by terms of the appended claims, and all changes which come within the meaning and range of equivalency of the claims are therefore intended to be embraced therein.

What is claimed is:

1. A staple remover for removing a staple from a bundle of papers fastened with the staple, comprising:
a deformation assisting part that bends a part of the bundle of papers, at which the bundle of papers has been fastened with the staple, with respect to a longitudinal direction of the staple; and
a first blade that is inserted between the bent bundle of papers and the staple, and removes the staple from the bundle of papers,
wherein the deformation assisting part includes a support part that supports the bundle of papers,
a communicating space is formed in the support part so as to allow a front surface and a back surface of the support part to communicate with each other in a thickness direction of the bundle of papers,
the bundle of papers is disposed such that the communicating space is located below the staple, and
the bundle of papers enters the communicating space to be bent, by being caught between the support part and the first blade.

2. The staple remover according to claim 1, wherein in the longitudinal direction, a difference between a width of the communicating space and a length of the staple is between 1 and 20 mm, inclusive.

3. A staple remover for removing a staple from a bundle of papers fastened with the staple, comprising:
a deformation assisting part that bends a part of the bundle of papers, at which the bundle of papers has been fastened with the staple, with respect to a longitudinal direction of the staple; and
a first blade that is inserted between the bent bundle of papers and the staple, and removes the staple from the bundle of papers,
wherein the deformation assisting part includes a support part that supports the bundle of papers, and
the staple is removed from the bundle of papers by the first blade operating while the bundle of papers is fixed on the support part.

4. The staple remover according to claim 3, wherein
a communicating space is formed in the support part so as to allow a front surface and a back surface of the support part to communicate with each other in a thickness direction of the bundle of papers,
the bundle of papers is disposed such that the communicating space is located below the staple, and
the bundle of papers enters the communicating space to be bent, by being caught between the support part and the first blade.

5. The staple remover according to claim 4, wherein in the longitudinal direction, a difference between a width of the communicating space and a length of the staple is between 1 and 20 mm, inclusive.

6. A staple remover for removing a staple from a bundle of papers fastened with the staple, comprising:
a deformation assisting part that bends a part of the bundle of papers, at which the bundle of papers has been fastened with the staple, with respect to a longitudinal direction of the staple; and
a first blade that is inserted between the bent bundle of papers and the staple, and removes the staple from the bundle of papers,
wherein the deformation assisting part includes a support part that supports the bundle of papers and is formed of an elastic member, and
the support part deforms as the bundle of papers is bent.

7. The staple remover according to claim 1, wherein before being bent by the deformation assisting part, the bundle of papers is substantially horizontal for 30 mm or more from the staple in a direction opposite to a direction in which the first blade is inserted.

8. The staple remover according to claim 1, wherein ends of the bundle of papers are not fixed on an extension line of the staple in the longitudinal direction.

9. The staple remover according to claim 1, wherein the bundle of papers is held at a point located upstream of the staple in a direction in which the first blade is inserted.

10. The staple remover according to claim 1, further comprising:
lift prevention members that restrict movement of the bundle of papers in a direction in which the bundle of papers lifts when the staple is removed by the first blade,
wherein the lift prevention members are disposed away from the bundle of papers before the staple is removed by the first blade.

11. The staple remover according to claim 10, wherein the lift prevention members are disposed at positions away from the staple along the longitudinal direction.

12. The staple remover according to claim 10, wherein the lift prevention members are disposed upstream of the staple in a direction in which the first blade is inserted.

13. The staple remover according to claim 10, wherein a distance from the lift prevention members to the support part in the thickness direction of the bundle of papers is larger than a thickness of the bundle of papers in a case where a number of paper sheets included in the bundle of papers is equal to a maximum allowable number of sheets for staple removal.

14. The staple remover according to claim 1, wherein the first blade has a wedge shape.

15. The staple remover according to claim 1, further comprising:
pressing parts disposed on a leg side of the staple; and
a second blade disposed on a crown side of the staple,
wherein the support part supports the bundle of papers from the crown side of the staple,
the first blade is disposed on the leg side of the staple, and
the second blade is inserted between the staple and the bundle of papers bent by being caught between the second blade and the pressing parts, and the staple is removed, after the first blade is inserted between the staple and the bundle of papers bent by being caught between the first blade and the support part, and legs of the staple are unfolded.

16. The staple remover according to claim 15, wherein the second blade is disposed upstream of the first blade in a direction in which the first blade is inserted.

17. The staple remover according to claim 15, wherein
the communicating space is formed in the support part so as to allow the front surface and the back surface of the support part to communicate with each other in the thickness direction of the bundle of papers,
the bundle of papers is disposed such that the communicating space is located below the staple, and
the bundle of papers enters the communicating space to be bent, by being caught between the support part and the first blade, and between the pressing parts and the second blade.

18. The staple remover according to claim 17, wherein the pressing parts are disposed inside an edge of the communicating space in the longitudinal direction.

19. The staple remover according to claim 3, wherein before being bent by the deformation assisting part, the bundle of papers is substantially horizontal for 30 mm or more from the staple in a direction opposite to a direction in which the first blade is inserted.

20. The staple remover according to claim 3, wherein ends of the bundle of papers are not fixed on an extension line of the staple in the longitudinal direction.

21. The staple remover according to claim 3, wherein the bundle of papers is held at a point located upstream of the staple in a direction in which the first blade is inserted.

22. The staple remover according to claim 3, further comprising:
lift prevention members that restrict movement of the bundle of papers in a direction in which the bundle of papers lifts when the staple is removed by the first blade,
wherein the lift prevention members are disposed away from the bundle of papers before the staple is removed by the first blade.

23. The staple remover according to claim 3, wherein the first blade has a wedge shape.

24. The staple remover according to claim 3, further comprising:
pressing parts disposed on a leg side of the staple; and
a second blade disposed on a crown side of the staple,
wherein the support part supports the bundle of papers from the crown side of the staple,
the first blade is disposed on the leg side of the staple, and
the second blade is inserted between the staple and the bundle of papers bent by being caught between the second blade and the pressing parts, and the staple is removed, after the first blade is inserted between the staple and the bundle of papers bent by being caught between the first blade and the support part, and legs of the staple are unfolded.

25. The staple remover according to claim 6, wherein before being bent by the deformation assisting part, the bundle of papers is substantially horizontal for 30 mm or more from the staple in a direction opposite to a direction in which the first blade is inserted.

26. The staple remover according to claim 6, wherein ends of the bundle of papers are not fixed on an extension line of the staple in the longitudinal direction.

27. The staple remover according to claim 6, wherein the bundle of papers is held at a point located upstream of the staple in a direction in which the first blade is inserted.

28. The staple remover according to claim 6, further comprising:
lift prevention members that restrict movement of the bundle of papers in a direction in which the bundle of papers lifts when the staple is removed by the first blade,
wherein the lift prevention members are disposed away from the bundle of papers before the staple is removed by the first blade.

29. The staple remover according to claim 6, wherein the first blade has a wedge shape.

30. The staple remover according to claim 6, further comprising:
pressing parts disposed on a leg side of the staple; and
a second blade disposed on a crown side of the staple,
wherein the support part supports the bundle of papers from the crown side of the staple,
the first blade is disposed on the leg side of the staple, and
the second blade is inserted between the staple and the bundle of papers bent by being caught between the second blade and the pressing parts, and the staple is removed, after the first blade is inserted between the staple and the bundle of papers bent by being caught between the first blade and the support part, and legs of the staple are unfolded.
